(19) United States
(12) Patent Application Publication
(10) Pub. No.: US 2006/0235743 A1
(43) Pub. Date: Oct. 19, 2006

(54) System and method for determining profitability scores

(75) Inventors: Kenneth C. Long, San Antonio, TX (US); Robert F. Romeo, Algonquin, IL (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, LP, Reno, NV (US)

(21) Appl. No.: 11/108,622

(22) Filed: Apr. 18, 2005

(51) Int. Cl. G06F 17/30

(52) U.S. Cl. 705/10

(57) ABSTRACT

A method for marketing a product to one or more customers includes retrieving a profitability score for the customer from a customer database. The product is selectively marketed to the one or more customers based on the profitability score. In a particular embodiment, a plurality of products can be bundled together to generate a bundle of products. The bundle of products can be selectively marketed to the customer. Further, the profitability score for the customer can be determined by determining a billed revenue for the customer over a predetermined time period and determining a collected revenue for the customer over the predetermined time period. Thereafter, the collected revenue is divided by the billed revenue to yield a percentage paid. Additionally, the percentage paid can be scaled to an integer between 1 and 999 to yield the profitability score.

### FIELD OF THE DISCLOSURE

The present disclosure relates generally to the marketing of products and services.

### BACKGROUND

In the telecommunications industry, determining potential customers to market new and existing products and services is important to the commercial success of a product or service. Commercial success of a product or service can be measured by the profits derived from the sale of the product or service, and increasing profits is a key goal. Often, a customer is deemed a “good” customer or a “bad” customer based on his or her credit score. Accordingly, products and services may be marketed to “good” customers and “bad” customers may be avoided. In many cases, some of the “bad” customers may only be slightly bad and depending on the profit margin of a particular product or service, potential profit may be realized with the marginally “bad” customers. Unfortunately, due to binary decision making, a company may avoid marketing to the marginally “bad” customers and lose profit opportunities.

Accordingly, there is a need for an improved system and method for predicting whether a customer will be profitable and marketing products and services to those customers likely to be profitable.

### BRIEF DESCRIPTION OF THE DRAWINGS

The present invention is pointed out with particularity in the appended claims. However, other features are described in the following detailed description in conjunction with the accompanying drawings in which:

FIG. 1 is a general diagram of a system for determining profitability scores for the telecommunication industry;

FIG. 2 is a flow chart to illustrate a method for determining a profitability score for one or more customers;

FIG. 3 is a flow chart to illustrate a method for marketing products and services to customers;

FIG. 4 is a flow chart to illustrate a method for determining target markets for different products and services; and

FIG. 5 is a flow chart to illustrate a method for determining when to contact a customer when a bill payment is late.

### DETAILED DESCRIPTION OF THE DRAWINGS

A method for marketing a product to one or more customers includes retrieving a profitability score for the customer from a customer database. The product is selectively marketed to the one or more customers based on the profitability score. Further, in a particular embodiment, the method includes predicting whether the product will be profitable if sold to the customer. This prediction is also based on the profitability score. In a particular embodiment, a plurality of products can be bundled together to generate a bundle of products. The decision concerning which products to bundle together can be based on the profitability score. Additionally, the bundle of products can be selectively marketed to the customer.

In another particular embodiment, a marginal cost for the product is determined. Also, a marginal revenue for the customer is determined based on the profitability score for the customer. Moreover, the customer name is selectively added to a target market table in product database based on the marginal cost and the marginal revenue. In a particular embodiment, the target market table in the product database can be used to market the product to a target market.

In yet another particular embodiment, the profitability score for the customer is determined by determining a billed revenue for the customer over a predetermined time period and determining a collected revenue for the customer over the predetermined time period. Thereafter, the collected revenue is divided by the billed revenue to yield a percentage paid. Additionally, the percentage paid can be scaled to an integer between 1 and 999 to yield a profitability score. The profitability score for the customer can be stored in a customer database.

In still another particular embodiment, the method further includes determining an average time to pay for the customer. The average time to pay for the customer is stored in a customer database. Further, the method includes detecting when a customer payment is late with respect to an overdue bill. When a customer payment is late, the profitability score for the customer is retrieved from the customer database. Also, the average time to pay for the customer is retrieved from the customer database. Based on the average time to pay for the customer and the profitability score for the customer, the method includes determining when to prompt the customer to pay the overdue bill.

In another embodiment, a system for predicting profitability of products includes a profitability datamart. Particularly, the profitability datamart includes a plurality of profitability scores stored therein. The profitability scores can be used for predicting whether a set of customers associated with each of the plurality of profitability scores is likely to generate a profit for one or more products.

In yet another embodiment, a system for determining profitability scores includes a server, a memory device in the server, and a processor that is coupled to the memory device. Additionally, the system includes a new account profitability scoring module that is embedded within the memory device. Also, a behavioral scoring module is embedded within the memory device. A billing module is embedded within the memory device. Moreover, a profitability datamart is coupled to the server.

In still another embodiment, a computer system includes a processor, a computer readable medium that is accessible to the processor, and a computer program that is embedded in the computer readable medium. In this embodiment, the computer program includes instructions to receive a billed revenue and a collected revenue for a customer over a predetermined time period. The computer program also includes instructions to determine a profitability score based on the billed revenue and the collected revenue. Further, the computer program includes instructions to selectively market one or more products to the customer based on the profitability score for the customer.

In yet still another embodiment, a computer system includes a processor, a computer readable medium that is accessible to the processor, and a computer program that is embedded in the computer readable medium. In this embodiment, the computer program includes instructions to determine an average time to pay for a customer during a predetermined time period. Also, the computer program includes instructions to determine a profitability score for the customer. The computer program further includes instructions to determine a prompt time for the customer based on the average time to pay and the profitability score.

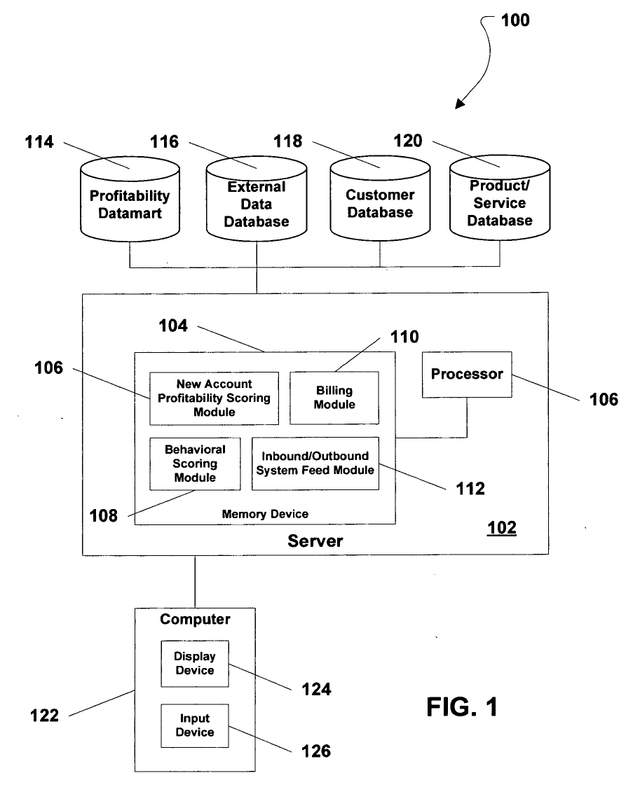

Referring initially to FIG. 1, a system for determining profitability scores for one or more customers is illustrated and is generally designated 100. As shown, the system 100 includes a server 102 having a memory device 104 and a processor coupled to the memory device 104. FIG. 1 also shows a new account profitability scoring module 106 within the memory 104. In a particular embodiment, the new account profitability scoring module 106 can be used to determine an acquisition profitability score for new customers. Particularly, the acquisition profitability score can be used to determine if it would be profitable to acquire a particular customer. Moreover, the acquisition profitability score can be used to assess the risk of acquiring a particular customer based on his or her payment history for other products and services.

As illustrated in FIG. 1, the system 100 can also include a behavioral scoring module 108 within the memory device 104 of the server 102. In a particular embodiment, the behavioral scoring module 108 can score all existing accounts at each billing cycle for profitability assessment and credit re-classification. Particularly, the accounts can be scored for the previous six months immediately prior to each billing cycle. Further, in a particular embodiment, the behavioral scoring module 108 utilizes internal credit data, internal demographic data, external credit data, and external demographic data in order to assess the potential future profitability of each customer for different products and services that are presently being offered or are proposed to be offered in the future.

Additionally, as depicted in FIG. 1, a billing module 1 10 can be embedded within the memory device 104. In an illustrative embodiment, the billing module 110 can generated customer bills and each billing cycle, the billing module 110 can provide customer billing information to the behavioral scoring module 108. The customer billing information can include billed revenue and collected revenue for each customer. FIG. 1 further indicates that an inbound/outbound system feed module 112 can be embedded within the memory device 104 of the server 102. In a particular embodiment, the inbound/outbound system feed module 112 can feed profitability information for each customer, product, and service to other systems for risk assessment and marketing cross-sell decisions.

Still referring to FIG. 1, a profitability datamart 114 can be coupled to the server 102. In a particular embodiment, the profitability datamart 114 includes several profitability index stores. Further, the profitability index stores can include a profitability index for each customer, an acquisition profitability score for one or more new customers, an account management profitability score for each customer, in-house credit data for each customer, and external credit and demographic data for each customer.

FIG. 1 also depicts an external database 116 that can be coupled to the server 102. In a particular embodiment, the server 102 can retrieve information from the external data storage device 116 that is relevant to the profitability determination undertaken for each new and existing customer, for each new and existing product, and for each new and existing service. Particularly, the external database 1 16 can include individual-level credit data and individual-level demographic data for each new and existing customer. Further, the external data can include aggregated demographic data. Also, the external database 116 can include other consumer market data that is useful for determining one or more profitability scores.

As illustrated in FIG. 1, a customer database 118 and a product/service database 120 can also be coupled to the server 102. In a particular embodiment, information related to products and services 120 targeted for each customer can be stored in the customer database 118. Further, in a particular embodiment, the product/service database 120 can store target market information, e.g., customer names and account information, for each product and service. FIG. 1 also shows a computer 122 coupled to the server 102. The computer 122 can include an input device 126 and a display device 124. In a particular embodiment, the computer 122 can be a laptop computer, a desktop computer, or a handheld computer. Further, in a particular embodiment, the input device 126 can be a manual input device, such as a keyboard, and can be used to input new and existing account information to the server 102 to be used by the new account profitability scoring module 104. Also, in a particular embodiment, the display device 112 can display a graphical user interface (GUI) that can be used to display one or more profitability indexes and one or more profitability scores.

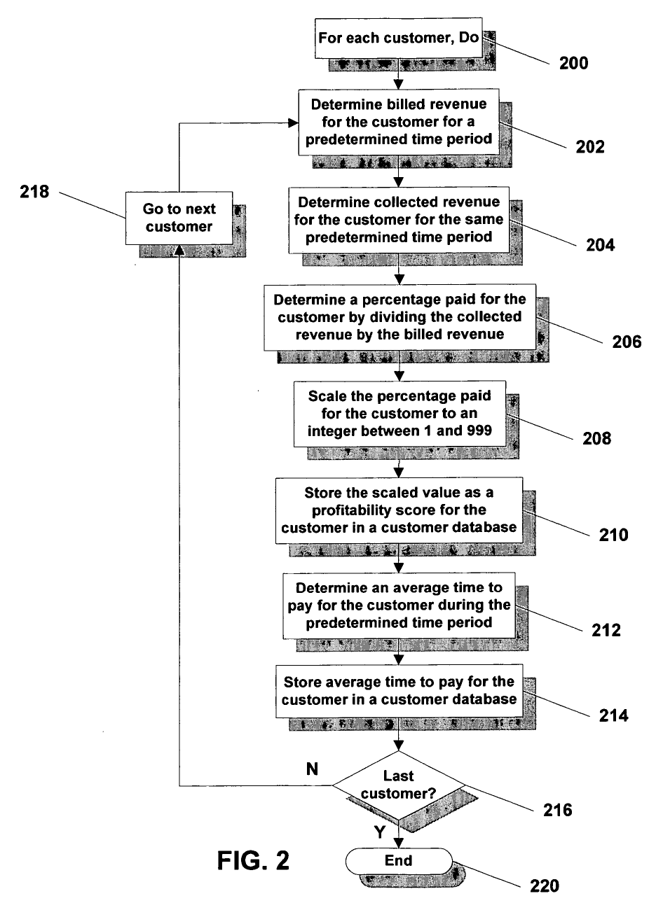

FIG. 2 depicts a method for determining a profitability score. Commencing at block 200, the following steps are performed for each customer. At block 202, billed revenue for the customer is determined for a predetermined time period, e.g., six months. Moving to block 204, collected revenue is determined for the customer for the same predetermined time period. Next, at block 206, a percentage paid is determined for the customer. In a particular embodiment, the percentage paid can be determined by dividing the collected revenue by the billed revenue. At block 208, the percentage paid for the customer is scaled to an integer between 1 and 999. Thus, a profitability score equal to 650 indicates that a customer is likely to pay 65% of his or her billed obligations. At block 210, the scaled value is stored as a profitability score for the customer. Particularly, the profitability score can be stored in the customer database 118 (FIG. 1).

Proceeding to block 212, an average time to pay is determined for the customer during the predetermined time period. At block 214, the average time to pay for the customer is stored. Particularly, the average time to pay can be stored in the customer database 118 (FIG. 1). Next, at decision step 216, a determination is made in order to ascertain whether the last customer is reached. If the last customer is not reached, the method continues to block 218 and the system evaluates the next customer. Then, the method returns to block 202 and continues as described above. Conversely, at decision step 214, if the last customer is reached, the logic ends at state 220.

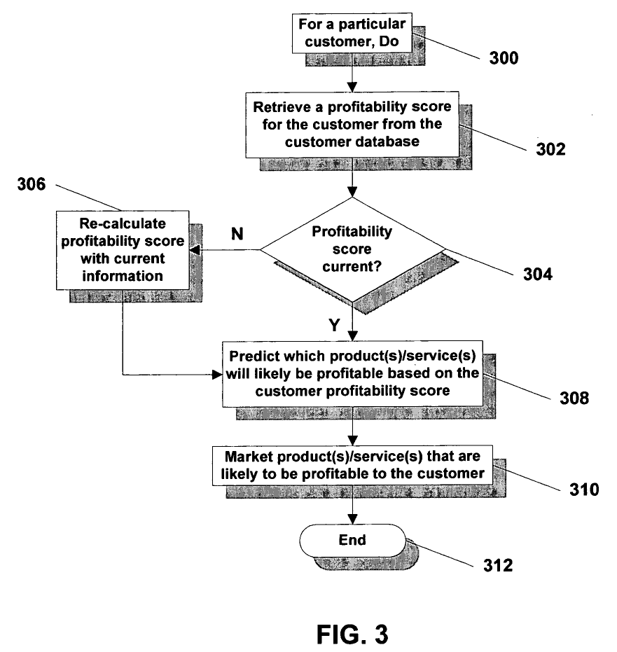

Referring to FIG. 3, a method for marketing products and services to one or more customers is portrayed and commences at block 300 where for a particular customer, the following steps are performed. At block 302, a profitability score for the customer is retrieved from the customer database 118 (FIG. 1). Next, at decision step 304, a decision is made in order to determine whether the profitability score is current. If the profitability score is not current, the logic moves to block 306 and the profitability score is re-calculated with current information. The logic then moves to block 308.

At decision step 304, if the profitability score is current, the logic moves to block 308 where it is predicted which products/services will likely be profitable based on the profitability score for the customer. Thereafter, at block 310, products and services that are likely to be profitable are marketed to the customer. The logic then ends at state 312.

In a particular embodiment, a single product or service can be marketed to the customer. In another embodiment, a bundle of products, a bundle of services, or a bundle of products and services can be marketed to the customer. The services can include high speed Internet services, digital satellite television services, telephone services, wireless telephone services, telephone equipment, and repair services. Particularly, the telephone services can include local services, long distance services, caller identification services, call waiting services, call forward services, three-way calling services, call blocking services, call returning services, and voice mail services.

Certain services, such as high-speed Internet, are relatively expensive to provide to a user. While other services, such as caller identification services, are relatively inexpensive to provide to a user. Thus, a particular customer may be likely to only generate a profit for the low cost services based on the profitability score and a group of low cost services may be bundled together and offered to that particular customer. On the other hand, another customer may have a relatively high profitability score and may be likely to generate a profit is sold the higher cost services. As such, the higher cost services can be bundled together and offered to this more attractive customer.

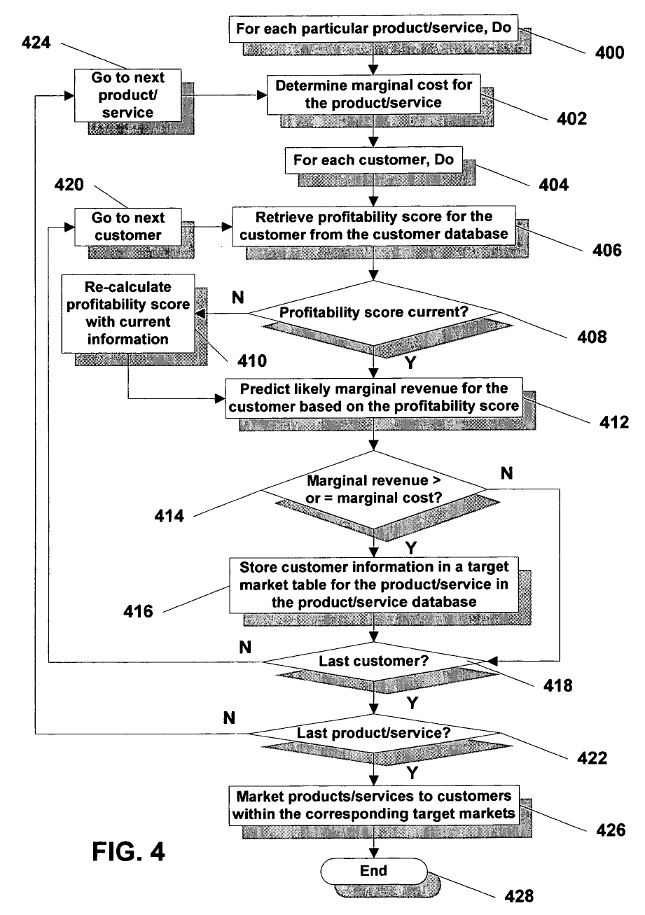

FIG. 4 illustrates a method for determining target markets for different products and services. At block 400, a loop is entered and for each product/service the succeeding steps are performed. At block 402, the marginal cost for the product/service is determined. Moving to block 404, another loop is entered and for each customer, the following steps are performed until the last customer is reached. At block 406, a percentage paid for the customer is retrieved from the customer database 118 (FIG. 1). Proceeding to block 408, a determination is made as to whether the profitability score for the customer is current. If the profitability score is not current, the method continues to block 410 and the profitability score is re-calculated with current information. Next, the logic moves to block 412.

Returning to decision step 408, if the profitability score is current, the method proceeds to block 412. At block 412, the likely marginal revenue for the customer is predicted. Particularly, the likely marginal revenue for the customer for that product/service is predicted based on the profitability score for the customer. Moving to decision step 414, a determination is made as to whether the marginal revenue is greater than or equal to the marginal cost. If the marginal revenue is greater than or equal to the marginal cost, the method moves to block 416 and the customer information is stored in a target market table for the product/service in the product/service database 120 (FIG. 1). Thereafter, the method proceeds to decision step 418.

Returning to decision step 414, if the marginal revenue is not greater than or equal to the marginal cost, the method moves to decision step 418 and the customer is not added to the target market table. At decision step 418, a decision is made to decide whether the last customer is reached. If the last customer is not reached, the method moves to block 420 and the system evaluates the next customer. The method then returns to block 406 and continues as described above. At decision step 418, if the last customer is reached, the method continues to decision step 422.

At decision step 422, a decision is made to determine whether the last product/service is reached. If not, the method returns to block 424 and the system goes to the next product/service. On the other hand, if the last product/service is reached, the method continues to block 426, and the identified products/services are offered to customers within the corresponding target markets as previously stored in the target market table. Then, the logic ends at state 428.

With the configuration of structure described above, the system and method for determining profitability scores, provides a way to predict the profitability of a customer based on his or her previous patterns and quantify the prediction as a profitability score. The system can also identify customers that may be profitable for one particular product or service, but not profitable for another product or service. Further, target markets can be identified for particular products and services based on the profitability scores of different customers.

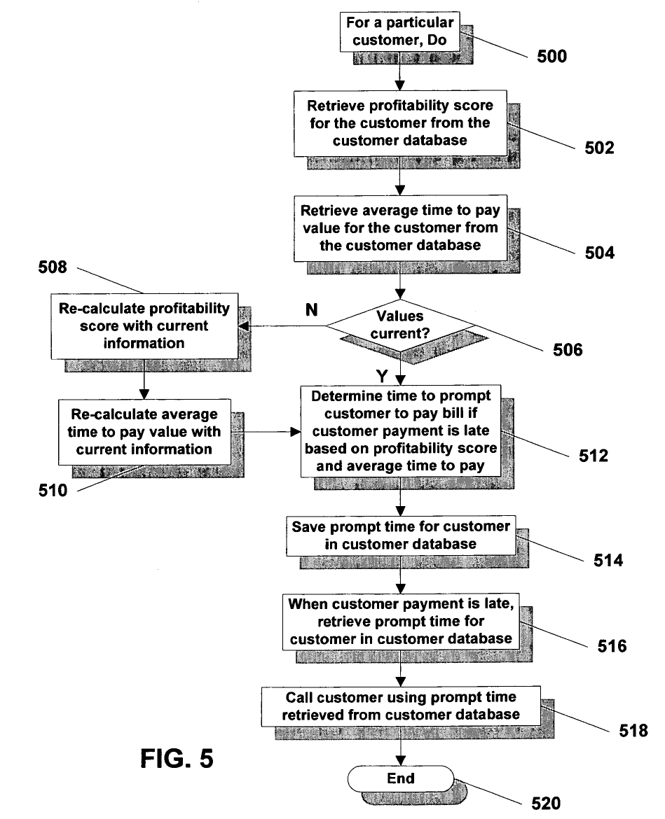

Referring now to FIG. 5, a method for determining when to call a customer when a bill payment is late is depicted and begins at block 500. At block 500, for a particular customer, the following steps are performed. Proceeding to block 502, a profitability score for the customer is retrieved from the customer database 118 (FIG. 1). Next, at block 504, an average time to pay value for the customer is retrieved from the customer database 118 (FIG. 1). Moving to block 506, a determination is made to ascertain whether the values are current. If not, the logic continues to block 508 and the profitability score is re-calculated with current information. Then, at block 510, the average time to pay is re-calculated with current information. The method then moves to block 512.

Returning to decision step 506, if the values are current the logic continues to block 512. At block 512, a time to prompt the customer to pay an overdue bill is determined. The time to prompt the customer to pay the overdue bill may be determined based on the profitability score for the customer and the average time to pay. Next, the prompt time for the customer can be saved in the customer database 118 (FIG. 1) at block 514. Moving to block 516, when a customer payment is late, the prompt time for the customer is retrieved from the customer database 118 (FIG. 1). At block 518, the customer is contacted regarding the late bill due when the bill payment time has exceeded the prompt time retrieved from customer database 118 (FIG. 1). The logic then ends at state 520. Using this method, a customer who is very profitable, but has a habit of paying late will not be driven away by excessive, annoying phone calls from customer billing agents. Moreover, requests for late payment may be dynamically performed based on a customer's profitability score, thereby more efficiently target collection resources to appropriate accounts.

In a particular embodiment, the methods disclosed comprise a series of logic steps that can be executed by any or all of the different components of the system 100 described herein. Further, the steps need not be executed in the order set forth in the figures. Also, any or all of the steps may be stored in any or all of the different components of the system 100. Moreover, as used herein, products can include services and services can include products.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method for marketing at least one product to one or more customers, the method comprising:
retrieving a profitability score for the customer from a customer database; and
selectively marketing the at least one product to the one or more customers selected at least partially based on the profitability score.

2. The method of claim 1, further comprising at least partially based on the profitability score, predicting whether the product will be profitable if sold to the customer.

3. The method of claim 2, further comprising:
at least partially based on the profitability score bundling a plurality of products to generate a bundle of products; and
selectively marketing the bundle of products to the customer.

4. The method of claim 1, further comprising;
determining a marginal cost for the at least one product;
predicting a marginal revenue for the customer at least partially based on the profitability score for the customer, and
at least partially based on the marginal cost and the marginal revenue, selectively adding a customer name to a target market table in a product database.

5. The method of claim 4, further comprising using the target market table in the product database to market the at least one product to a target market.

6. The method of clam 1, wherein the profitability score for the customer is determined by:
determining a billed revenue for the customer over a predetermined time period;
determining a collected revenue for the customer over the predetermined time period; and
dividing the collected revenue by the billed revenue to yield a percentage paid.

7. (canceled)

8. The method of claim 6, further comprising storing the profitability score for the customer in a customer database.

9. (canceled)

10. (canceled)

11. (canceled)

12. A system for predicting profitability of products, comprising:
a profitability datamart, the profitability datamart including a plurality of profitability scores stored therein for predicting whether a set of customers associated with each of the plurality of profitability scores is likely to generate a profit for one or more products.

13. The system of claim 12, further comprising a behavioral scoring module coupled to the profitability datamart, the behavioral scoring module assessing a plurality of existing accounts to determine the plurality of profitability scores based on billed revenues for each existing account and collected revenues for each existing account.

14. The system of claim 13, firmer comprising a billing module coupled to the behavioral scoring module, the billing module providing customer billing information associated with each existing account to the behavioral scoring module.

15. The system of claim 14, wherein the customer billing information includes the billed revenues and the collected revenues for each existing account.

16. The system of claim 12, further comprising a new account profitability scoring module coupled to the profitability datamart, the new account profitability scoring module assessing a plurality of potential customers to determine an acquisition profitability score for each potential customer based on credit information acquired by the profitability datamart.

17. The system of claim 16, further comprising an external database coupled to the profitability datamart, the external database providing credit information for the plurality of potential customers to the profitability datamart.

18. The system of claim 17, wherein the credit information includes billing revenues and collected revenues for each potential customer and the acquisition profitability score for each potential customer is determined at least partially based on the billing revenues and collected revenues for each potential customer.

19. A system for determining profitability scores, the system comprising:
a server;
a memory device within the server;
a processor coupled to the memory device;
a new account profitability scoring module embedded within the memory device;
a behavioral scoring module embedded within the memory device;
a billing module embedded within the memory device; and
a profitability datamart coupled to the server.

20. The system of claim 19, further comprising an inbound/outbound system feed module embedded within the memory device.

21. The system of claim 20, further comprising an external data database coupled to the server.

22. The system of claim 21, further comprising a customer database coupled to the server.

23. The system of claim 22, further comprising a product database coupled to the server.

24. The system of claim 23, further comprising a user computer coupled to the server.

25. The system of claim 24, wherein the user computer includes a display device and an input device.

26. A computer system, comprising:
a processor;
a computer readable medium accessible to the processor;
a computer program embedded in the computer readable medium, the computer program comprising:
instructions to receive a billed revenue for a customer over a predetermined time period;
instructions to receive a collected revenue over the customer for the predetermined time period;
instructions to determine a profitability score based on the billed revenue and the collected revenue; and
instructions to selectively market at least one product to the customer at least partially based on the profitability score for the customer.

27. The computer system of claim 26, wherein the computer program further comprises instructions to determine a marginal cost for a product.

28. The computer system of claim 27, wherein the computer program further comprises instructions to predict a marginal revenue for the customer at least partially based on the profitability score for the customer.

29. The computer system of claim 20, wherein the computer program further comprises instructions to selectively add the customer to a target market table within a product database at least partially based on the marginal revenue and the marginal cost.

30. The computer system of claim 29, wherein the customer is added to the target market table when the marginal revenue is greater than or equal to the marginal cost.

31. The computer system of claim 30, wherein the computer program further comprises instructions to selectively offer products to the customers within the target market table.

32. (canceled)

33. (canceled)

34. (canceled)

35. (canceled)

36. (canceled)

37. (canceled)
